(19) United States
(12) Patent Application Publication
(10) Pub. No.: US 2021/0152117 A1
(43) Pub. Date: May 20, 2021

(54) WINDOW MOUNTED PHOTOVOLTAIC SYSTEM

(71) Applicant: Hall Labs LLC, Provo, UT (US)

(72) Inventors: David R. Hall, Provo, UT (US); Jerome Miles, Spanish Fork, UT (US); Seth Myer, Provo, UT (US)

(73) Assignee: Hall Labs LLC, Provo, UT (US)

(21) Appl. No.: 16/684,584

(22) Filed: Nov. 14, 2019

(51) Int. Cl. H02S 20/26; H02S 30/10; H02S 40/34

(52) U.S. Cl. CPC H02S 20/26; H02S 40/34; H02S 30/10

(57) ABSTRACT

The invention is a photovoltaic system mounted to the inside surface of a window. The system comprises photovoltaic modules on a substrate along with a sheet of material which is visually similar to the substrate which are both adhesively attached to the interior surface of a window, facing towards the outside of the building. The light incident side of the substrate with photovoltaic cells faces the exterior of the building facing the sun. Electrical connectors are integrated into the substrate and connected to solar cells within the photovoltaic modules, thus providing electrical connection of the system to external electrical devices or electrical systems near the window that require power.

### TECHNICAL FIELD

This invention relates to photovoltaic systems.

### BACKGROUND

Solar power systems for residential applications typically consist of an array of solar photovoltaic panels mounted to a racking system on the roof of a house. In many instances, a large amount of solar energy is needed to provide power for the entire house. There are some cases where a small amount of electrical power is needed for devices inside the house. A roof top mounted system may be larger than what is really needed for these low power devices or systems.

Disadvantages of traditional roof mounted systems include the fact that the solar panels are on the outside of the house and require a roof penetration to get the wiring from the outside of the house to the interior of the house where the power is needed. These penetrations introduce the possibility for leaks at the penetration that may cause water damage. Another feature of a roof mounted system is that the solar panels are exposed to the elements (rain, wind, snow, hail, tree branches falling on or scraping against) that could be damaging or destructive to the solar panels. Traditional solar power systems are further exposed to temperature extremes that may degrade the performance and shorten the useful life of the solar panels.

There are many cases where power is required near a window on the interior space of a building that does not have power available at the window. This may be desirable even in houses that have a traditional solar power system on the roof of the house. Examples of devices that may require power near or at a window or sliding door include automated (motor driven) window coverings, along with motorized window or sliding door systems that open and close a window or door.

By placing the solar photovoltaic modules on the inside of the house at or near the window, many of the disadvantages of a roof mounted system may be resolved. The solar modules are on the inside of the house and are therefore not exposed to the elements and temperature extremes, thus improving performance and extending the life of the solar modules. No roof penetrations are required so there is no risk of water intrusion causing damage.

There are known interior mounted solar photovoltaic systems that include a solar panel or solar PV cells mounted near a window, in between the panes of window glass, or even inside the window glass itself. These known systems overcome many of the disadvantages of a traditional roof mounted system. However, most of these systems are expensive to manufacture and in many cases are not retrofittable to existing windows.

For example, in some of the known interior mounted solar photovoltaic systems, the solar modules are enclosed in a frame that is attached to a headrail above a window or attached to a window frame. In this example, there are costs associated with the manufacturing of the frame itself that structurally supports the solar cells within the modules.

### SUMMARY

In one aspect, the invention is a photovoltaic system mounted to the inside surface of a window. The system comprises photovoltaic modules on a substrate along with a sheet of material which is visually similar to the substrate which are both adhesively attached to the interior surface of a window, facing towards the outside of the building. The light incident side of the substrate with photovoltaic cells facing the exterior of the building facing the sun. Electrical connectors are integrated into the substrate and connected to solar cells within the photovoltaic modules, thus providing electrical connection of the system to external electrical devices or electrical systems near the window that require power.

In a preferred embodiment, the photovoltaic system mounted to the inside surface of a window may comprise photovoltaic modules on a substrate along with a sheet of material which is visually similar to the substrate which are both adhesively attached to the interior surface of a window, facing towards the outside of the building. The light incident side of the substrate with photovoltaic cells facing the exterior of the building facing the sun. Electrical connectors may be integrated into the substrate and connected to solar cells within the photovoltaic modules, thus providing electrical connection of the system to external electrical devices or electrical systems near the window that require power.

This invention has been developed in response to the present state of the art and, in particular, in response to the problems and needs in the art that have not yet been fully solved by currently available systems and methods. Features and advantages of different embodiments of the invention will become more fully apparent from the following description and appended claims or may be learned by practice of the invention as set forth hereinafter.

Consistent with the foregoing, a window mounted photovoltaic system is disclosed. The objectives of the system are to provide a photovoltaic system mounted to the inside surface of a window comprising photovoltaic modules on a substrate along with a sheet of material which is visually similar to the substrate which are both adhesively attached to the interior surface of a window, facing towards the outside of the building. The light incident side of the substrate with photovoltaic cells facing the exterior of the building facing the sun. Electrical connectors may be integrated into the substrate and connected to solar cells within the photovoltaic modules, thus providing electrical connection of the system to external electrical devices or electrical systems near the window that require power.

In a preferred embodiment, A window mounted photovoltaic system may include a photovoltaic module. The photovoltaic module may include a generally planar substrate having a first and second major sides, two or more photovoltaic cells with one side on the first major side of the substrate and a layer of contact adhesive covering at least a portion of a light incident side of the photovoltaic cells. The photovoltaic module may be deployed by attachment to an interior surface of a window with the layer of contact adhesive.

In another embodiment, at least a portion of the adhesive which covers the light incident side of the PV cells may be light transmissive. The light transmissive portion of the adhesive may also be UV resistant. There may also be a release coating covering the contact adhesive allowing the release coating to be removed at the time of installation exposing the adhesive to simplify installation.

In certain embodiments, the layer of contact adhesive covers the entire light incident side of the substrate. In an embodiment, a total surface area of the first side of the substrate may be larger than a photovoltaically active area of the one or more photovoltaic cells, thus creating a photovoltaically non-active border area on the first side. In one embodiment, the border area may be an area surrounding the outside of the photovoltaically active area creating an outside border area. In another embodiment, the border area may run between at least two of the one or more photovoltaic cells creating an inside border area between the photovoltaic cells. In an embodiment, the layer of contact adhesive may cover all of the border area. In yet another embodiment, the contact adhesive covering the outside border area may completely surround the photovoltaic cells once the substrate is adhesively attached to a window surface. In a certain embodiment, the contact adhesive covering the outside border area may not completely surround the photovoltaic cells, leaving openings for air to be passively transmitted between the substrate and the window surface.

In an embodiment, the photovoltaic module may consist of a flexible thin-film solar material having the ability to bend up to 30 degrees. In another embodiment, the photovoltaic module may consist of a semi-flexible material having the ability to bend up to 5 degrees.

In certain embodiments, the photovoltaic module may also include a first terminal and a second terminal which are in electrical communication with the photovoltaic cells. The terminals may be disposed in a first electrical connector which may be supported on the substrate. At least one electrical conductor with a mating electrical connector may be plugged into the first electrical connector, wherein the conductor may then be extended to an electrical device or circuit. The conductor may be extended to a motorized window covering; wherein the photovoltaic module may provide power to the motorized window covering. In yet another embodiment, the conductor may also be extended to a motorized window opener; wherein the photovoltaic module may provide power to the motorized window opener. In an embodiment, the conductor may be extended to a motorized door opener, and the photovoltaic module may also provide power to the motorized door opener.

In another embodiment, the photovoltaic system may further include a sheet of material that looks visually similar to the substrate. The sheet of material may be deployed adjacent to the substrate by attachment to the interior surface of the window with contact adhesive.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a section view of a house showing the sun's rays shining on to a window mounted photovoltaic module.

FIG. 2 is an isometric view of a window with the photovoltaic system, according to one example embodiment.

FIG. 3A is a front view of a window on the interior of a house showing the photovoltaic system and electrical device.

FIG. 3B is a side section view of a window with photovoltaic module mounted to the top of the window.

FIG. 4A is a front view of a window on the interior of a house showing another embodiment of the photovoltaic system mounted to a window.

FIG. 4B is a side section view of a window with photovoltaic module vertically mounted along the side of the interior pane of the window.

FIG. 5A is a side section view of another embodiment of a window with photovoltaic module mounted to the top of the window.

FIG. 5B is a side section view of an additional embodiment of a window with photovoltaic module 110 mounted to the top of the window.

FIG. 6A is a partial side section of an enlarged view of a window with photovoltaic module mounted to the top of the window.

FIG. 6B is a front view of a window on the exterior of a house showing the photovoltaic module.

FIG. 7A is a partial side section of an enlarged view of another embodiment of a window with photovoltaic module mounted to the top of the window.

FIG. 7B is a front view of a window on the exterior of a house showing the photovoltaic module with air flow.

FIG. 8 is a front view of a window on the exterior of a house showing two rows of photovoltaic modules.

FIG. 9 is a perspective view of a sliding window/door system with a window covering.

FIG. 10 is a perspective view of a motorized sliding window/door system.

FIG. 11 is an isometric view of the photovoltaic system including photovoltaic module and sheet material.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

“Solar modules” and “photovoltaic modules,” as referred to throughout this document, refer to an electrical module that produces energy, collects energy, produces power, transmits power, conducts electricity, communicates energy, converts energy from one form to another, and combinations of one or more of the foregoing.

The term “flexible” when referencing a photovoltaic module describes a flexible thin-film solar material having the ability to bend up to 30 degrees without breaking. Flexible solar panels are preferably built with the solar collecting material impregnated into a thin mylar film that is affixed to a flexible aluminum substrate.

“Semi-flexible” refers to a photovoltaic module that is comprised of a semi-flexible material having the ability to bend up to 5 degrees without breaking. Semi flexible solar panels typically comprise solar cells that may not bend too far without being damaged or breaking. They are preferably built with the solar collecting material impregnated into a less flexible substrate such as fiberglass.

One advantage of the preferred embodiment is that solar modules are mounted to the actual window surface on the inside of the house facing out towards the outside of the house, being exposed to the sun. In this fashion, the window itself becomes the support structure for the solar cells, thus minimizing the amount of material within the solar module that is needed to structurally support the cells. The structural framework supporting a substrate or planar material upon which the solar cells are mounted to may be minimized since the window structure will be supporting the solar module once it has been installed.

In some cases, the solar module may be comprised of a solar thin-film material. In the case of a thin-film solar module, the flexible nature of the thin-film allows it to be easily handled and installed onto the surface of a window. The thin-film module may further comprise a peel and stick adhesive feature that allows it to be adhesively attached to the window surface. Flexible solar panels are superior to their stiff counterparts in many ways. They're lighter and thinner and they have the ability to bend up to an average of 30 degrees. One advantage of flexible solar panels is the ability to install on irregular or curved surfaces as needed in certain applications.

Semi flexible solar panels are also lighter and thinner than rigid solar panels yet have a more robust construction than flexible solar panels. Semi flexible solar panels allow flexibility to bend up to 5 degrees. The minimal flexibility of the semi flexible solar panels may provide enough flexibility in many cases to install the panels onto the window surface.

In summary, the key advantages of the preferred embodiment of the present invention include a system that:
provides a cost-effective solar power system that may provide power to electrical devices or systems near a window in a house;
does not require a frame or support structure, because the window itself is the support;
provides a solar power system that may be installed in the interior space of a house;
may be retrofitted to an existing window;
allows the solar modules to be mounted directly to the inside surface of a window;
may be directly attached to the window without any other separate support structure;
can be configured to provide an air gap area between the modules and the window for air flow;
simplifies installation by providing a peel and stick adhesive system that allows the attachment of the modules to a window; and
further simplifies the installation by making the electrical connection of the modules to an electrical device or electrical interconnection system by a simple plug-in connection.

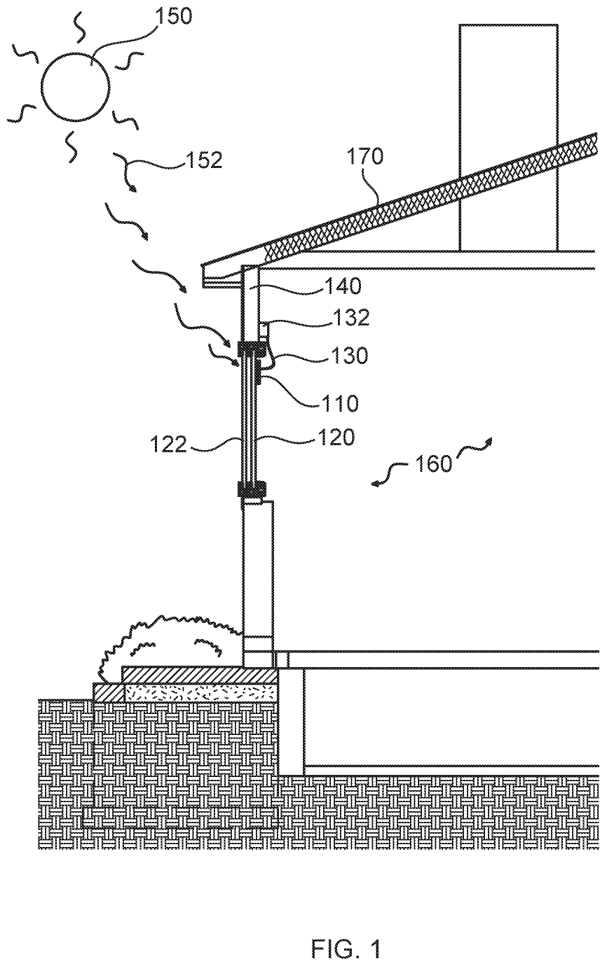

Referring to the drawings, FIG. 1 is a section view of a house showing the sun's rays shining on to a window mounted photovoltaic module. A section view of house 170 is shown with a window installed in exterior wall 140. Photovoltaic module 110 is located on the interior 160 of the house 170 on an inside surface of an interior pane 120 of the window. Sun 150 is shown with solar energy rays 152 shining on to the light incident side of photovoltaic module 110, passing through exterior pane 122 and interior pane 120 of the window. The photovoltaic module 110 produces electrical power which is supplied via electrical conductor 130 to electrical device 132. In this embodiment, the electrical device 132 is directly above the photovoltaic module 110. Since the electrical device 132 is located above the window, there are no readily accessible electrical outlets or receptacles near the upper part of wall 140. This necessitates the provision of power from the window mounted photovoltaic system. The electrical device 132 may comprise a motor or actuator that is wirelessly controlled from a wireless network. The wireless network may be Bluetooth, WiFi or other wireless technology that does not require wiring to be installed. In this way, the system is completely autonomous without the need of running additional wires on the interior of the house beyond the wiring 130 that connects the photovoltaic system to the device 132.

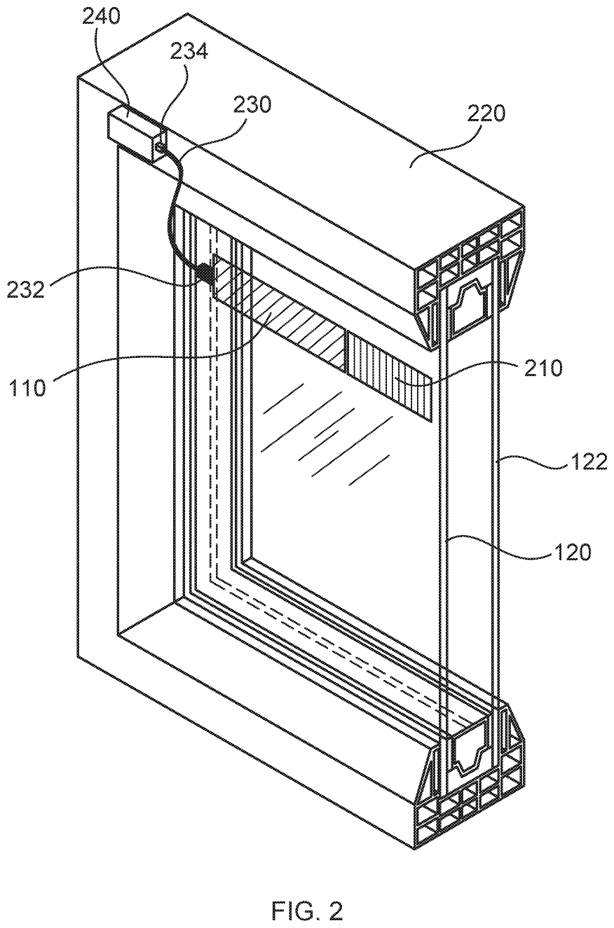

FIG. 2 is an isometric view of a window with the photovoltaic system, according to one example embodiment. In this drawing, the window frame 220 is shown with electrical device 240 mounted to the header of window frame 220. Photovoltaic module 110 is adhesively mounted directly to interior pane 120. Exterior pane 122 is shown on the exterior side of the window. Sheet of material 210 looks visually similar to the photovoltaic module 110 and is mounted directly adjacent to the photovoltaic module 110 as shown. This makes the entire top section of the interior pane 120 have a unified dark (photovoltaic module 110 is a dark color in this embodiment) band of color extending across the entire top section of the interior pane 120 when viewed from the exterior of the house (looking towards the window). This provides for an aesthetically pleasing look that does not detract from the overall look of the window 220 when viewed from the exterior of the house. In this embodiment, the interior side of both photovoltaic module 110 and sheet of material 210 are white in color so as to look aesthetically pleasing on the interior of the house. The surface of the interior of photovoltaic module 110 and sheet of material 210 may also be painted to match the interior decor of the house. The sheet of material 210 may be comprised of plastic, cardboard, paper, or any other material that may be manufactured for a lower price than the photovoltaic module 110. The sheet of material 210 may be supplied in a long piece that may be cut on site to fit the size of the window. In this way, the photovoltaic system comprising the photovoltaic module 110 and sheet of material 210 may be adjusted to fit any window size.

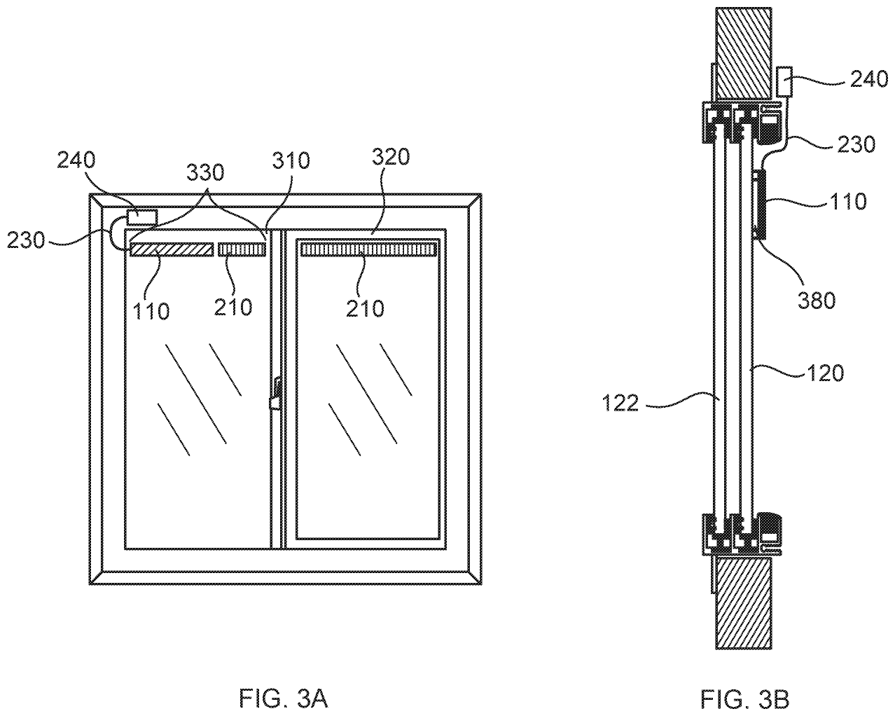

FIG. 3A is a front view of a window on the interior of a house showing the photovoltaic system and electrical device 240. Photovoltaic module 110 is shown adhesively attached to fixed window 310. When sliding window 320 is being opened or closed, the wiring 230 that is extended to electrical device 240 is not impacted by the travel of sliding window 320. The side of module 110 and sheet material 210 facing the interior of the house is white in color. The combined overall look 330 of module 110 and material 210 is aesthetically pleasing and looks like one continuous white component. An additional sheet material 210 may be mounted to the top of sliding window 320 as shown. This makes the overall look consistent between the two windows.

FIG. 3B is a side section view of a window with photovoltaic module 110 mounted to the top of the window. Exterior pane 122 faces the exterior of the house and interior pane 120 faces the interior of the house. Photovoltaic module 110 is adhesively attached to interior pane 120 with adhesive 380. In this embodiment the adhesive 380 is shown along the top and bottom borders of photovoltaic module 110. Wiring 230 is shown running from photovoltaic module 110 up to electrical device 240.

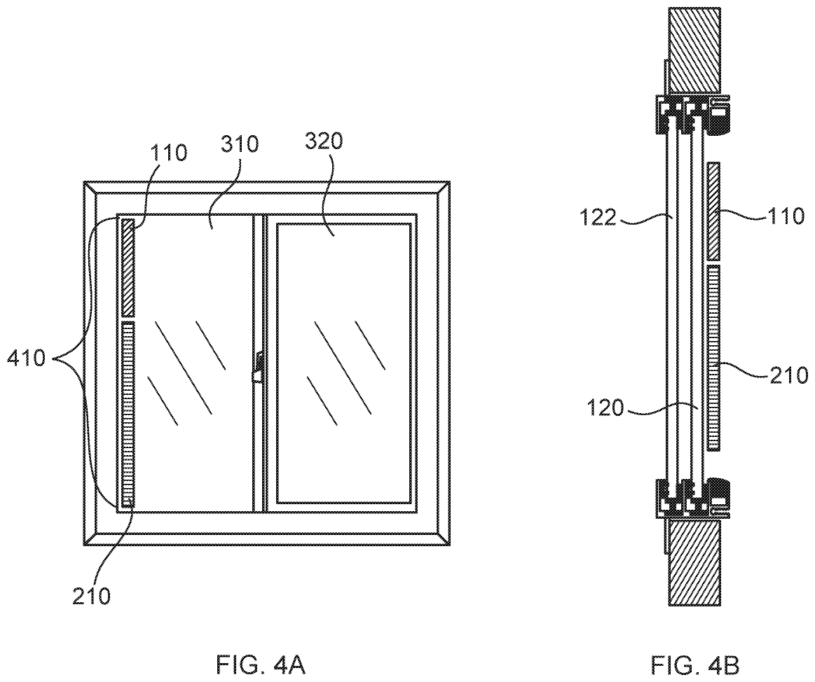

FIG. 4A is a front view of a window on the interior of a house showing another embodiment of the photovoltaic system mounted to a window. Photovoltaic module 110 is shown running vertically rather than horizontally along one side of fixed window 310. Photovoltaic module 110 is adhesively attached to fixed window 310. The side of module 110 and sheet material 210 facing the interior of the house is white in color. The combined overall look 410 of module 110 and material 210 is aesthetically pleasing and looks like one continuous white component.

FIG. 4B is a side section view of a window with photovoltaic module 110 vertically mounted along the side of the interior pane 120 of the window. Exterior pane 122 faces the exterior of the house and interior pane 120 faces the interior of the house.

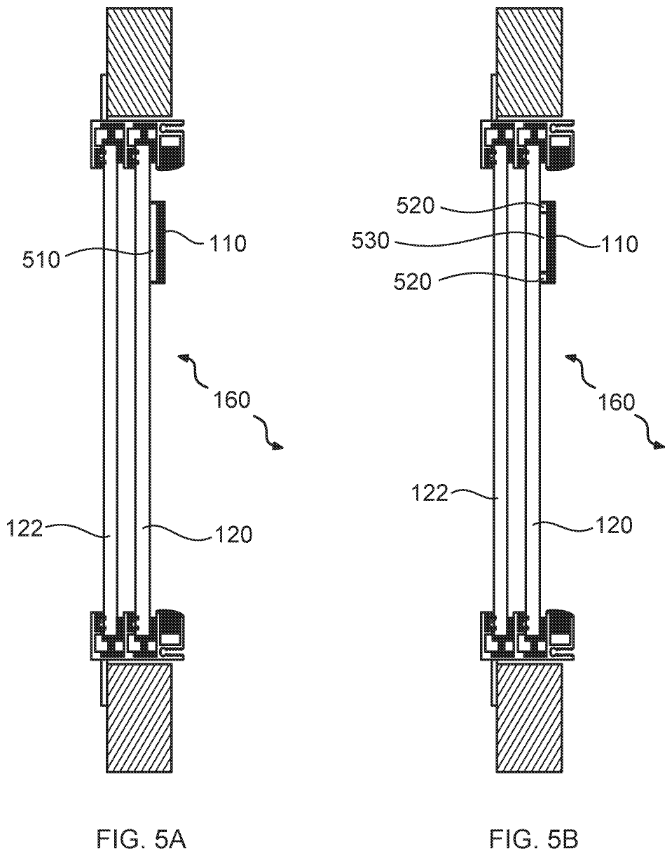

FIG. 5A is a side section view of another embodiment of a window with photovoltaic module 110 mounted to the top of the window. Exterior pane 122 faces the exterior of the house and interior pane 120 faces the interior of the house. Photovoltaic module 110 is adhesively attached to interior pane 120 with optically clear adhesive 510. In this embodiment the adhesive 510 covers the entire surface of the light incident side of photovoltaic module 110. In this embodiment, the adhesive is optically clear and UV resistant. The interior space 160 is shown.

FIG. 5B is a side section view of an additional embodiment of a window with photovoltaic module 110 mounted to the top of the window. Exterior pane 122 faces the exterior of the house and interior pane 120 faces the interior of the house. Photovoltaic module 110 is adhesively attached to interior pane 120 with opaque adhesive 520. In this embodiment the adhesive 520 runs along a border surrounding the photovoltaically active area of photovoltaic module 110. In this embodiment, the adhesive is not needed to be light transmissive since it is not blocking the sunlight coming in. The interior space 160 is shown.

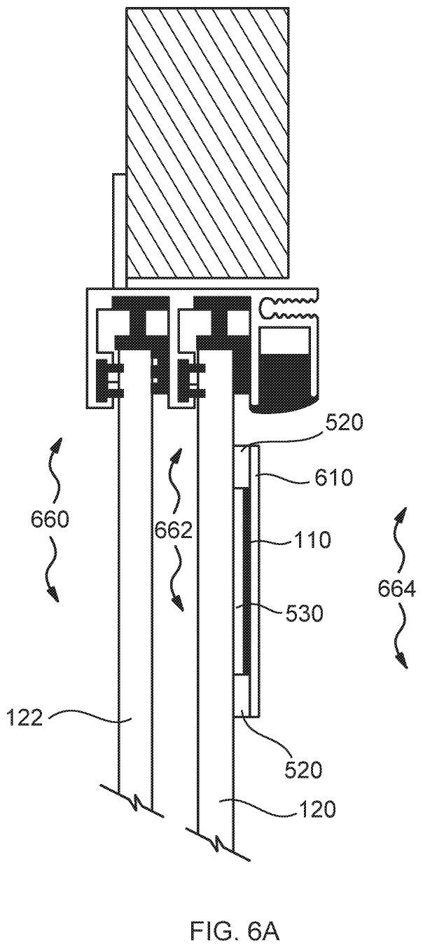

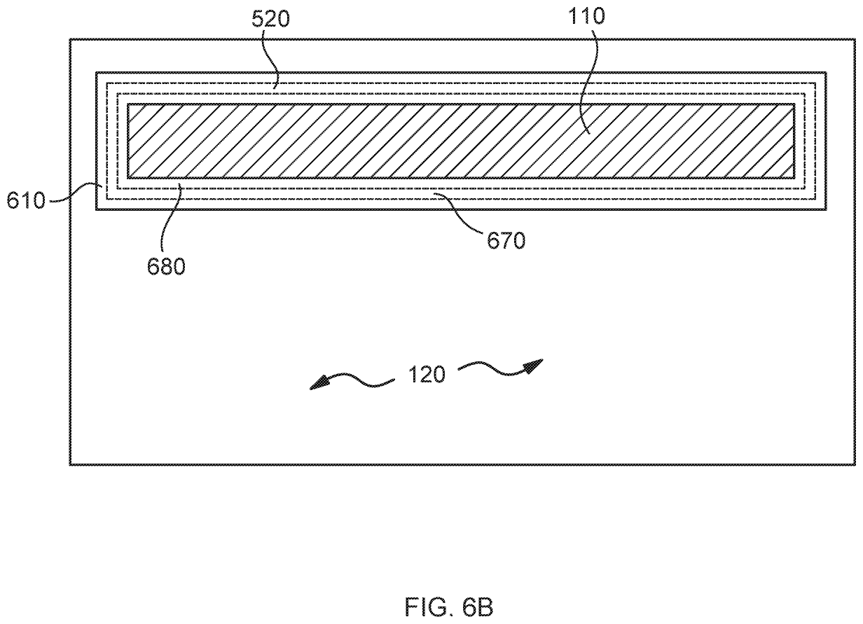

FIG. 6A is a partial side section of an enlarged view of a window with photovoltaic module 110 mounted to the top of the window. Exterior pane 122 faces the exterior of the house and interior pane 120 faces the interior of the house. Photovoltaic module 110 is adhesively attached to interior pane 120 with opaque adhesive 520. In this embodiment the adhesive 520 runs along a border surrounding the photovoltaically active area of photovoltaic module 110. In this embodiment, planar substrate 610 is shown with photovoltaic module 110 comprising photovoltaic cells attached to the substrate 610. Substrate 610 may be a circuit board that has photovoltaic cells attached to it. The border surrounding the photovoltaic cells may be a part of this substrate 610. Exterior temperature 660 is higher in the Summer than temperature 662 between exterior pane 122 & interior pane 120. Temperature 664 on the interior of the house is lower than both temperatures 660 and 662. Temperature 530 between interior pane 120 and photovoltaic module 110 is also lower than both temperatures 660 and 662. The performance of photovoltaic module 110 is improved by its location next to the glass. In this embodiment, the proximity of the photovoltaic module 110 to the surface of the interior glass 120 enhances the production over modules that are not as close to the glass. This is because the efficiency of the photovoltaic module 110 is enhanced when the temperature differential is greater between the light incident side (photovoltaically active side) of the photovoltaic module 110 and the back side (substrate 610). The closer the photovoltaic cells are to the glass, the greater the power production will be. In a like manner, on Winter days the temperature near the window is higher since it is closer to the solar radiation which produces heat via convection. Conductive heat is also generated by the enclosed (by adhesive 520) area between the photovoltaic module 110 and interior pane 120.

FIG. 6B is a front view of a window on the exterior of a house showing the photovoltaic module 110. Photovoltaic module 110 is shown mounted to substrate 610. Adhesive 520 is shown which adhesively and structurally attaches substrate 610 to the interior pane 120. Adhesive 520 completely surrounds the photovoltaic module 110 creating a dead air space within outside border area 680.

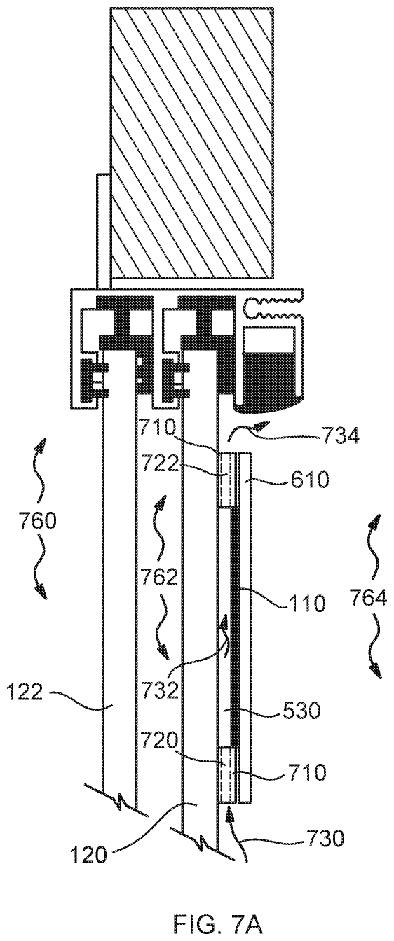

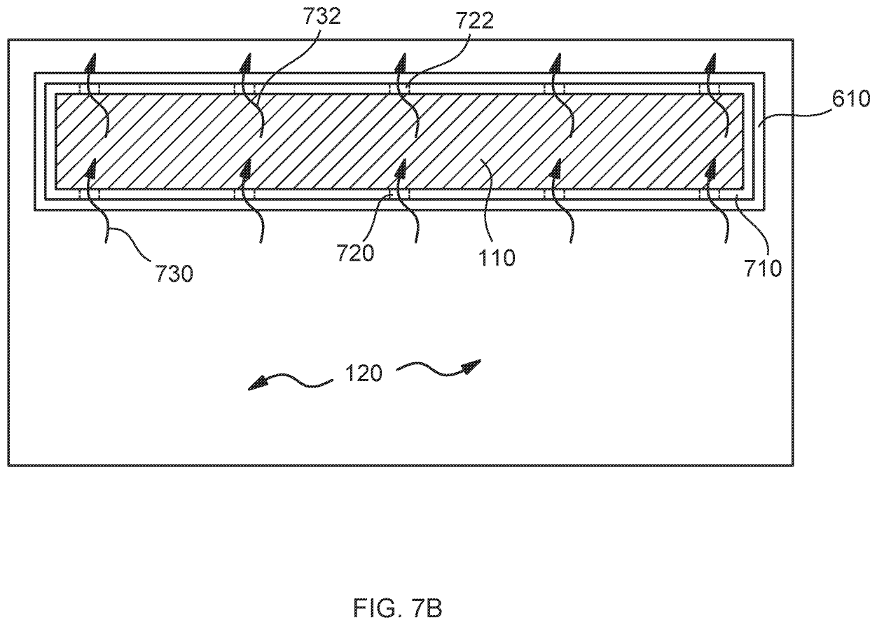

FIG. 7A is a partial side section of an enlarged view of another embodiment of a window with photovoltaic module 110 mounted to the top of the window. Exterior pane 122 faces the exterior of the house and interior pane 120 faces the interior of the house. Photovoltaic module 110 is adhesively attached to interior pane 120 with adhesive 710. In this embodiment the adhesive 710 runs along a border surrounding the photovoltaically active area of photovoltaic module 110. In this embodiment, planar substrate 610 is shown with photovoltaic module 110 comprising photovoltaic cells attached to the substrate 610. Substrate 610 may be a circuit board that has photovoltaic cells attached to it. The border surrounding the photovoltaic cells may be a part of this substrate 610. Exterior temperature 760 is higher in the Summer than temperature 762 between exterior pane 122 & interior pane 120. Temperature 764 on the interior of the house is lower than both temperatures 760 and 762. Temperature 530 between interior pane 120 and photovoltaic module 110 is also lower than both temperatures 760 and 762. The performance of photovoltaic module 110 is improved by its location next to the glass. In this embodiment, the proximity of the photovoltaic module 110 to the surface of the interior glass 120 enhances the production over modules that are not as close to the glass. This is because the efficiency of the photovoltaic module 110 is enhanced when the temperature differential is greater between the light incident side (photovoltaically active side) of the photovoltaic module 110 and the back side (substrate 610). The closer the photovoltaic cells are to the glass, the greater the power production will be. In this embodiment, opening 720 within the adhesive 710 at the bottom of the photovoltaic module 110 allows the natural convection of heat created within space 530 to draw air 730 in at the bottom of the system up through the opening 710 at the bottom of the system. The air 732 is drawn across the front surface of the photovoltaic module 110 and drawn up and out through opening 722 as heated air 734 exits the top of the system. This embodiment may be used in geographical areas that have extremely hot temperatures wherein it will not allow the front facing light incident side of the photovoltaic module 110 to get too hot. The natural cooling of the air flow 732 will keep the photovoltaic module 110 cool.

FIG. 7B is a front view of a window on the exterior of a house showing the photovoltaic module with air flow. Photovoltaic module 110 is shown mounted to substrate 610. Adhesive 710 is shown which adhesively and structurally attaches substrate 610 to the interior pane 120. In this embodiment, adhesive 710 has a series of lower openings 720 that allow air 730 to be drawn in through openings 720 and up through top openings 722 as heated air 732 exits out the top.

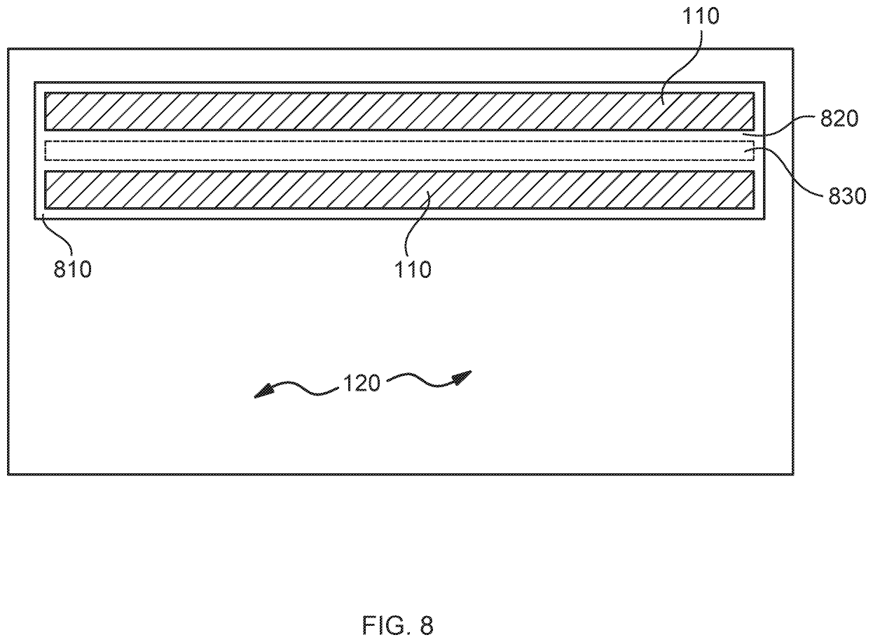

FIG. 8 is a front view of a window on the exterior of a house showing two rows of photovoltaic modules 110. Photovoltaic modules 110 are shown mounted to substrate 810. Adhesive 830 is shown which adhesively and structurally attaches substrate 810 to the interior pane 120. In this embodiment, adhesive 830 is shown running along interior border area 820 separating two photovoltaic module sections 110.

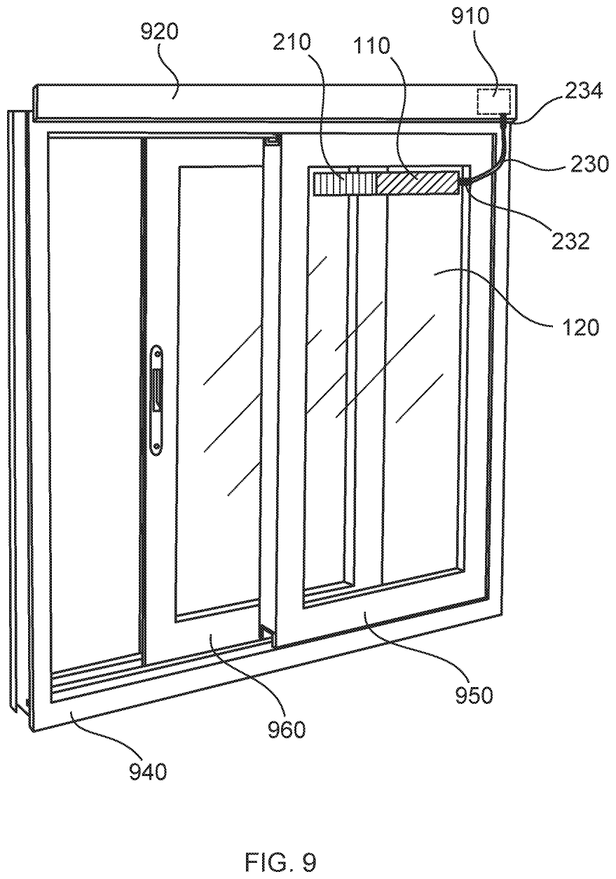

FIG. 9 is a perspective view of a sliding window/door system with a window covering. The window covering can be in the form of automated blinds, such as those shown in U.S. Pat. No. 9,540,871, entitled MOTORIZED GEARBOX ASSEMBLY WITH THROUGH-CHANNEL DESIGN. The window covering can also be in the form of an automated roller shade, such as that shown in U.S. Published Patent Application No. 2018-0266176 and entitled Motorized Roll-Up Window Shade. Interior pane 120 is shown on stationary section 950. Photovoltaic module 110 and material 210 are shown near the top of interior pane 120. Connector 232 electrically connects to terminals within connector 232 to photovoltaic module 110 and extends power via conductors 230 to connector 232 which connects to electric motor 910. The motor 910 inside window covering 920 powers a gearbox or mechanical actuator that operates the window covering mechanism. Sliding section 960 is shown within frame 940. The frame 940 together with stationary section 950 and sliding section 960 may comprise a sliding window system or a sliding door system. The system may also comprise other window and door systems that are capable of opening and closing, along with systems that may have motorized systems associated with the window or door that require power to operate.

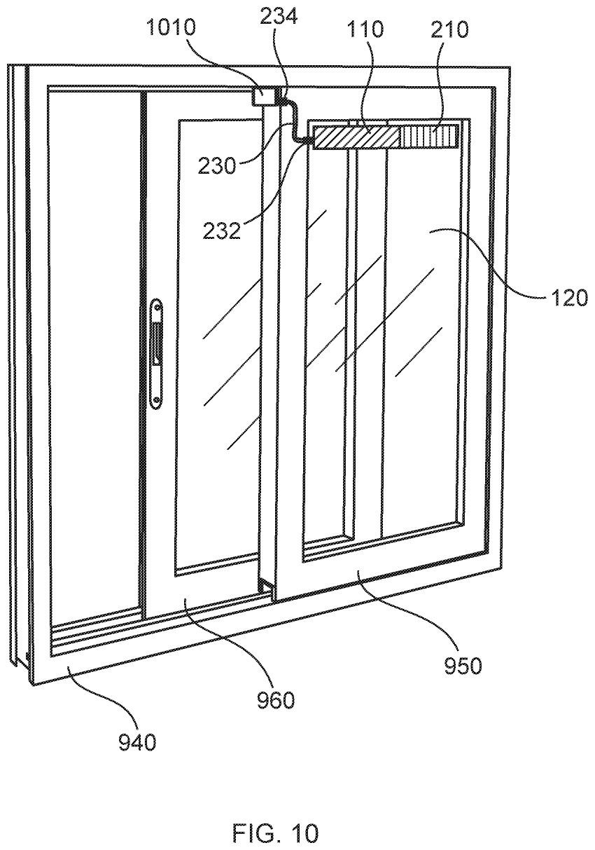

FIG. 10 is a perspective view of a motorized sliding window/door system. One preferred such system is described and depicted in U.S. Published Patent Application No. 2019-0003236, entitled Gear-Driven Automated Window or Door System. Interior pane 120 is shown on stationary section 950. Photovoltaic module 110 and material 210 are shown near the top of interior pane 120. Connector 232 electrically connects to terminals within connector 232 to photovoltaic module 110 and extends power via conductors 230 to connector 232 which connects to electric motor 1010. The motor 1010 mechanically opens and closes sliding section 960. Sliding section 960 is shown within frame 940. The frame 940 together with stationary section 950 and sliding section 960 may comprise a sliding window system or a sliding door system.

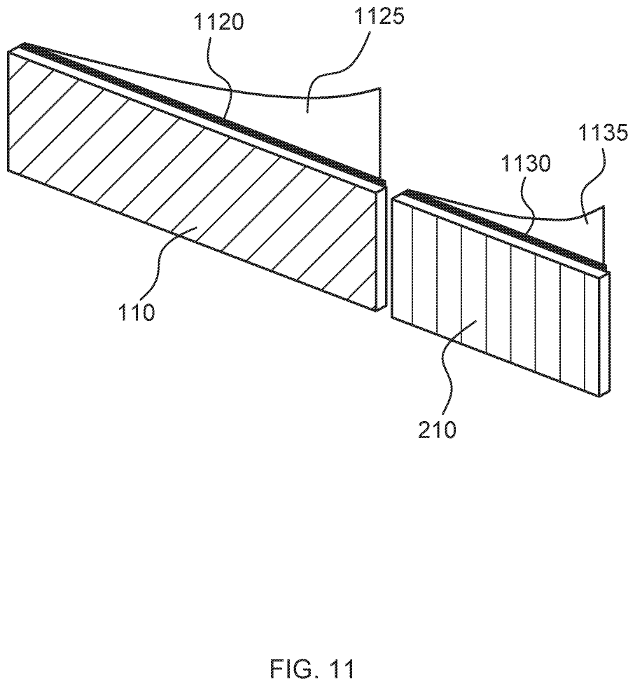

FIG. 11 is an isometric view of the photovoltaic system including photovoltaic module 110 and sheet material 210. Adhesive 1120 on the light incident side of photovoltaic module 110 is shown together with release coating 1125 covering the adhesive 1120. When the photovoltaic module 110 is installed on to a window, the release coating 1125 is removed thus exposing adhesive 1120 allowing the photovoltaic module 110 to be adhesively attached to the window. In a like manner, adhesive 1130 on the light incident side of sheet material 210 is shown together with release coating 1135 covering the adhesive 1130. When the sheet material 210 is installed on to a window, the release coating 1135 is removed thus exposing adhesive 1130 allowing the sheet material 210 to be adhesively attached to the window.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A photovoltaic system comprising:
a photovoltaic module comprising:
a generally planar substrate having a first and second major sides;
two or more photovoltaic cells with one side on the first major side of the substrate; and
a layer of contact adhesive covering at least a portion of a light incident side of the photovoltaic cells;
whereby the photovoltaic module is deployed by attachment to an interior surface of a window with the layer of contact adhesive.

2. The invention of claim 1, wherein at least a portion of the adhesive which covers the light incident side of the PV cells is light transmissive.

3. The invention of claim 2, wherein the light transmissive portion of the adhesive is UV resistant.

4. The invention of claim 1, further including a release coating covering the contact adhesive.

5. The invention of claim 1, wherein the layer of contact adhesive covers the entire light incident side of the substrate.

6. The invention of claim 1, wherein a total surface area of the first side of the substrate is larger than a photovoltaically active area of the one or more photovoltaic cells, thus creating a photovoltaically non-active border area on the first side.

7. The invention of claim 6, wherein the border area is an area surrounding the outside of the photovoltaically active area creating an outside border area.

8. The invention of claim 6, wherein the border area runs between at least two of the one or more photovoltaic cells creating an inside border area between the photovoltaic cells.

9. The invention of claim 6, wherein the layer of contact adhesive covers all of the border area.

10. The invention of claim 7, wherein the contact adhesive covering the outside border area completely surrounds the photovoltaic cells once the substrate is adhesively attached to a window surface.

11. The invention of claim 7, wherein the contact adhesive covering the outside border area does not completely surround the photovoltaic cells, leaving openings for air to be passively transmitted between the substrate and the window surface.

12. The invention of claim 1, wherein the photovoltaic module is comprised of a flexible thin-film solar material having the ability to bend up to 30 degrees.

13. The invention of claim 1, wherein the photovoltaic module is comprised of a semi-flexible material having the ability to bend up to 5 degrees.

14. The invention of claim 1, further including a first terminal and a second terminal which are in electrical communication with the photovoltaic cells.

15. The invention of claim 14, wherein the terminals are disposed in a first electrical connector which is supported on the substrate.

16. The invention of claim 15, wherein at least one electrical conductor with a second electrical connector is plugged into the first electrical connector, wherein the conductor is extended to an electrical device or circuit.

17. The invention of claim 16, wherein the conductor is extended to a motorized window opener; wherein the photovoltaic module provides power to the motorized window opener.

18. The invention of claim 16, wherein the conductor is extended to a motorized window covering; wherein the photovoltaic module provides power to the motorized window covering.

19. The invention of claim 1, wherein the window is a sliding door with at least one section of transparent glazing material.

20. The invention of claim 1, wherein the photovoltaic system further comprises a sheet of material that looks visually similar to the substrate; whereby the sheet of material is deployed adjacent to the substrate by attachment to the interior surface of the window with contact adhesive.
